(19) United States
(12) Patent Application Publication
(10) Pub. No.: US 2025/0118812 A1
(43) Pub. Date: Apr. 10, 2025

(54) ENDOTHERMIC PHASE-CHANGE MATERIAL COATED SEPARATORS FOR BATTERIES

(71) Applicant: FORD GLOBAL TECHNOLOGIES, LLC, DEARBORN, MI (US)

(72) Inventors: Insik Jeon, Novi, MI (US); Jonghwan Park, Ann Arbor, MI (US)

(21) Appl. No.: 18/481,605

(22) Filed: Oct. 5, 2023

(51) Int. Cl. H01M 10/42; H01M 50/414; H01M 50/417; H01M 50/42; H01M 50/426; H01M 50/434; H01M 50/443; H01M 50/457; H01M 50/489; H01M 50/581

(52) U.S. Cl. CPC H01M 10/4235; H01M 50/414; H01M 50/417; H01M 50/42; H01M 50/426; H01M 50/434; H01M 50/443; H01M 50/457; H01M 50/489; H01M 50/581; H01M 2200/10

(57) ABSTRACT

A battery component is provided. The battery component may comprise a separator including a porous substrate, a ceramic coating on a surface of the porous substrate, and solid unencapsulated endothermic phase change material particles on or in the ceramic coating and configured to melt upon reaching a phase transition temperature and fill pores in the surface of the porous substrate.

### TECHNICAL FIELD

The present disclosure relates to phase change material coatings for separators in lithium-ion batteries.

### BACKGROUND

Lithium-ion batteries have been used for energy storage in portable electronics, large-scale smart grids, and electric vehicles. A lithium-ion battery is composed of three main functional components, namely the anode or negative electrode, cathode or positive electrode, and electrolyte. Typically, a separator is placed in between the negative electrode and the positive electrode to prevent physical contact and thus an electrical short of the two electrodes, while up-taking electrolyte and allowing ion transport between the electrodes. Generally, the separator does not directly participate in any chemical reaction in the battery but plays a role in determining battery performance, including cycle life, energy density, and power density, through influencing kinetics of the battery cell. A separator should be chemically, mechanically, and electrochemically stable under the strongly reactive environment inside the battery during operation.

### SUMMARY

According to one embodiment, a battery component is provided comprising a separator. The separator includes a porous substrate, a ceramic coating on a surface of the porous substrate, and solid unencapsulated endothermic phase change material particles on or in the ceramic coating. The solid unencapsulated endothermic phase change materials are configured to melt upon reaching a phase transition temperature and fill pores in the surface of the porous substrate.

In an alternative embodiment, a battery cell is provided comprising positive and negative electrodes, a separator disposed between the electrodes, and electrolyte saturating the separator and in contact with the electrodes. The separator includes a porous substrate, a ceramic coating on opposite sides of the porous substrate, and solid unencapsulated endothermic phase change material particles on or in the ceramic coating. The solid unencapsulated endothermic phase change material particles are configured to melt upon achieving a phase transition temperature, fill pores on the sides of the porous substrate, and hinder ion transport between the electrodes.

In yet another embodiment, a battery cell is provided comprising positive and negative electrodes, a separator disposed between the electrodes, and electrolyte saturating the separator and in contact with the electrodes. The separator includes a porous substrate and solid unencapsulated endothermic phase change material particles. The solid unencapsulated endothermic phase change material particles are configured to melt upon achieving a phase transition temperature, fill pores of the porous substrate, and hinder ion transport between the electrodes.

### BRIEF DESCRIPTION OF THE DRAWINGS

FIG. 1A is a schematic of a separator according to an embodiment.

FIG. 1B is a schematic of a separator according to another embodiment.

FIG. 2A is a schematic of a separator according to an alternative embodiment.

FIG. 2B is schematic of a separator according to yet another embodiment.

FIG. 3 is a schematic of the separator of FIG. 1B after the phase change material has undergone phase change.

FIG. 4 is a cross-sectional view of a battery device including an exemplary separator.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Lithium-ion batteries include electrodes, electrolyte, and separators. Separators physically separate positive and negative electrodes to prevent internal shorts. Separators may include polyolefin-based porous films. The typical thickness of a polyolefin-based porous film is between 5 and 30 μm.

Separators can also provide a function called shutdown to prevent thermal runaway. Thermal runaway is a self-reinforcing increase in temperature within a battery cell that leads to chemical reactions that generate heat. This can occur when the battery is subjected to conditions that cause it to overheat, including overcharging, short-circuiting, or exposure to high temperatures. Thermal runaway can cause electrolyte to breakdown and release gases, and/or degrade internal components.

When battery cell temperature approaches the melting point of a separator, generally referred to as the shutdown temperature, separator pores close and block the migration of lithium-ions between electrodes, thus preventing further electrochemical operation, which in turn prevents increase of battery cell temperature and thermal runaway.

Conventional separators may be produced by blending high-density polyethylene (“HDPE”) and ultra-high molecular weight polyethylene (“UHMWPE”) for mechanical strength and thermal stability. The use of UHMWPE increases shutdown temperature, typically higher than 140° C., due to the increased molecular weight and high crystallinity. A lower shutdown temperature, about 130° C. or less, could quicken shutdown speed. A separator made using a resin with a lower crystallinity and melting point can lower shutdown temperature by lowering the melting point of the separator. However, this can affect the porous film's mechanical strength.

A phase change material (“PCM”) is a material that releases or absorbs energy at and during phase transition, which can be used to provide useful heating or cooling properties. Generally, the transition is from one of the first two fundamental states of matter, solid and liquid. A PCM can be applied to a battery separator to further control the shutdown temperature of the battery cell.

According to an embodiment of the present disclosure, heat absorbing or endothermic PCM is coated on a porous separator film. The PCM may have a melting point around 130° C. or lower. Upon heating caused by a short, overcharging, or other excessive heat-generating event, the PCM approaches its phase transition temperature. At phase change, the PCM endothermically absorbs heat and melts, transitioning from solid to liquid or a high viscosity status. The liquid or high viscosity status of the PCM enables the material to fill and close separator pores. The liquid or high viscosity material filling pores increases the resistance of the separator and may eventually lead to thermal shutdown by cutting off lithium-ion transport.

Thus, the PCM coating may serve two functions: an additional and more efficient shutdown layer than the melting of the porous film by permitting shutdown of the cell at a lower temperature without affecting the mechanical properties of the porous film, and endothermic heat absorption thereby cooling hot spots and affecting thermal control within the battery cell.

In one example, PCM may be coated on a single side of a separator. In another example, PCM may be coated on both sides of a separator. PCM may include a hydrocarbon such as polyolefins, paraffins, or a combination thereof. PCM may include a polymer such as polyolefins, fluoropolymers, polyethylene oxides, acrylics, or a combination thereof. PCM may also include ionic liquids. PCM may be selected from a single or combination of these materials. Depending on the material selected, the melting point of the PCM is in the range of about 90 to 150° C. and preferably between about 110 and 130° C. PCM particles may have a D50 of about 0.1 to 2 μm. The PCM coating may have a thickness of about 0.5 to 10 μm.

The separator may include a ceramic coating layer. The ceramic coating layer may affect separator thermal stability, mechanical stability, and electrolyte wettability. Ceramic particles may include alumina, boehmite, silica, or a combination thereof. Average ceramic particle size may be between about 0.1 and 2 μm and preferably between 0.2 and 1 μm.

In one example, the PCM is coated on the surface of the ceramic coating layer. The PCM may be coated on one or opposite sides of the separator. In another example, PCM may be embedded in the ceramic coating layer. The PCM may be embedded in one or opposite sides of the separator.

A binder material may be used to hold ceramic particles, PCM particles, or both, together and to the porous film. The binder material may include acrylics, carboxymethylcellulose, methylcellulose, styrene-butadiene rubber, polyvinyl alcohol, polyvinylpyrrolidone, fluoropolymers, polyurethane, polyacrylamide, curable monomers, or a combination thereof.

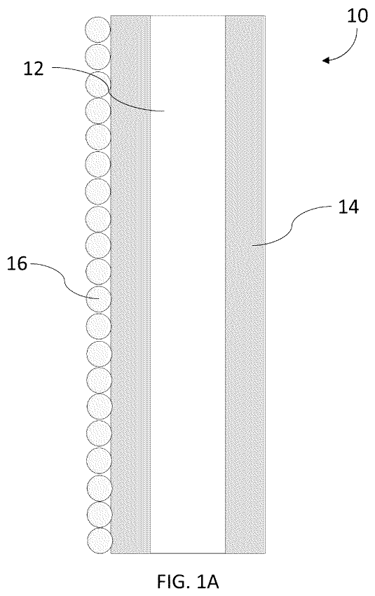

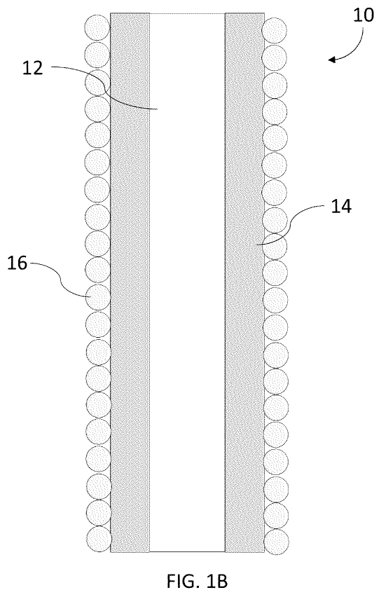

FIG. 1A schematically depicts an exemplary separator 10 according to an embodiment. Separator 10 includes porous substrate 12, ceramic coating 14 on a surface of porous substrate 12, and solid unencapsulated endothermic PCM particles 16 on ceramic coating 14. Ceramic coating 14 may comprise ceramic particles including alumina, boehmite, silica, or a combination thereof, having a D50 of about 0.1 to 2 μm. PCM particles 16 may be a hydrocarbon, including polyolefins, paraffins, or a combination thereof. PCM particles 16 may also be a polymer, including polyolefins, fluoropolymers, polyethylene oxides, acrylics, or a combination thereof. PCM particles 16 may further be ionic liquids.

In a variation depicted in FIG. 1B, separator 10 may include solid unencapsulated endothermic PCM particles 16 on ceramic coating 14 on opposite sides of porous substrate 12. In either variation, PCM particles 16 may have a D50 of about 0.1 to 2 μm and a phase transition temperature or melting point of about 90 to 150° C. but preferably in the range of 110 to 130° C. PCM particles 16 may form a layer on ceramic coating 14 having a thickness of about 0.5 to 10 μm.

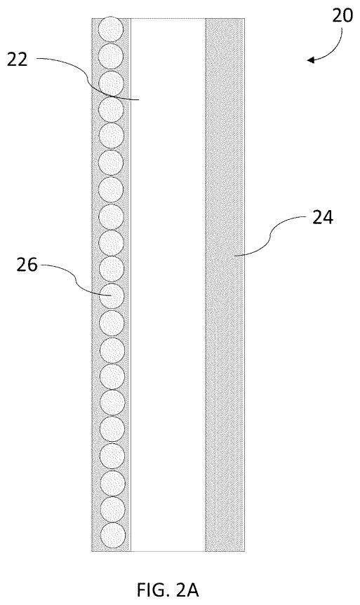

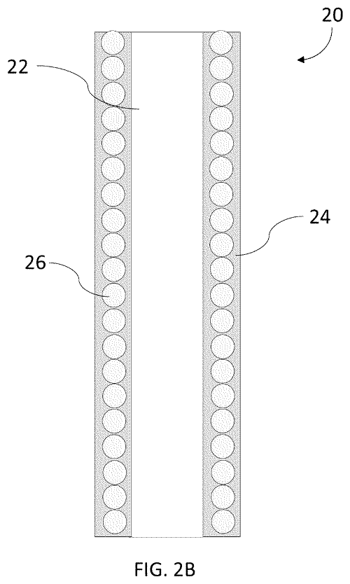

FIG. 2A schematically depicts an exemplary separator 20 according to another embodiment. Separator 20 includes porous substrate 22, ceramic coating 24 on a surface of porous substrate 22, and solid unencapsulated endothermic PCM particles 26 embedded in ceramic coating 24. Ceramic coating 24 may comprise ceramic particles including alumina, boehmite, silica, or a combination thereof, having a D50 of about 0.1 to 2 μm. PCM particles 26 may be a hydrocarbon, including polyolefins, paraffins, or a combination thereof. PCM particles 26 may also be a polymer, including polyolefins, fluoropolymers, polyethylene oxides, acrylics, or a combination thereof. PCM particles 26 may further be ionic liquids.

In a variation depicted in FIG. 2B, separator 20 may include solid unencapsulated endothermic PCM particles 26 embedded in ceramic coating 24 on opposite sides of porous substrate 22. In either variation, PCM particles 26 may have a D50 of about 0.1 to 2 μm and a phase transition temperature or melting point of about 90 to 150° C. but preferably in the range of 110 to 130° C.

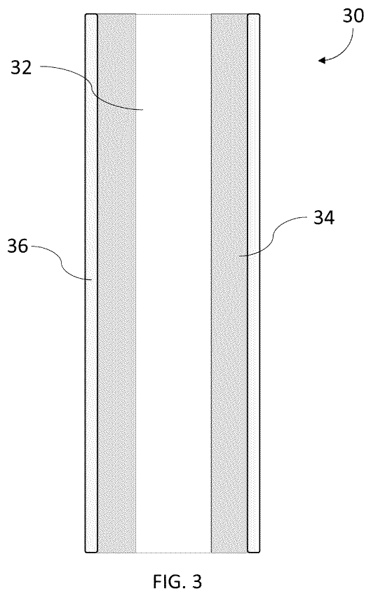

FIG. 3 schematically depicts an exemplary separator 30 according to an embodiment after reaching the phase transition temperature of the PCM. Separator 30 includes porous substrate 32, ceramic coating 34 on a surface of porous substrate 32, and solid unencapsulated endothermic PCM particles 36 on ceramic coating 34. PCM particles 36 absorbed heat and transitioned from solid to liquid or a high viscosity status upon reaching phase transition temperature, subsequently filling pores in the surface of porous substrate 32, increasing resistance across separator 30, and hindering or preventing ion transport across separator 30.

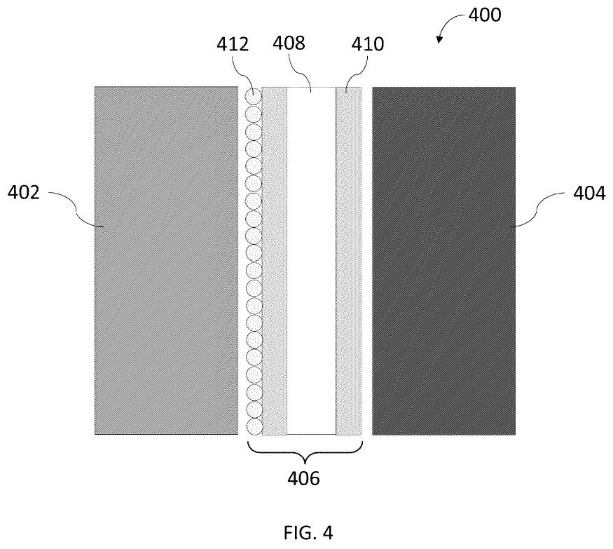

FIG. 4 is a cross sectional view of an exemplary battery device 400. Battery device 400 includes a negative electrode 402, a positive electrode 404, and separator 406 according to an embodiment. Although not depicted, battery device 400 includes electrolyte between and in contact with negative electrode 402 and positive electrode 404. Negative electrode 402 is an electrode containing material that undergoes oxidation reactions in which atoms release electrons during operation and may include carbon materials such as graphite or lithium metal. Positive electrode 404 is an electrode containing material that undergoes reduction reactions in which atoms gain electrons during operation and may include lithium metal oxides. Separator 406 includes porous substrate 408, ceramic coating 410 on a surface of porous substrate 408, and solid unencapsulated endothermic PCM particles 412 on ceramic coating 410. In an alternative embodiment, separator 406 may include solid unencapsulated PCM particles on ceramic coating 410 on opposite sides of porous substrate 408. In yet another embodiment, separator 406 may include solid unencapsulated PCM particles embedded in ceramic coating 410 on one or opposite sides of porous substrate 408.

PCM particles 412 may have a phase transition temperature or melting point of about 90 to 150° C., preferably in the range of 110 to 130° C. When battery device 400 reaches the phase transition temperature, PCM particles 412 absorb heat and transition from solid to liquid or a high viscosity status, filling porous substrate 408 pores and increasing resistance across separator 406 thereby hindering or preventing ion transport from negative electrode 402 to positive electrode 404.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A battery component comprising:
a separator including a porous substrate, a ceramic coating on a surface of the porous substrate, and solid unencapsulated endothermic phase change material particles on or in the ceramic coating and configured to melt upon reaching a phase transition temperature and fill pores in the surface.

2. The separator of claim 1, wherein the phase change material particles includes a hydrocarbon.

3. The separator of claim 2, wherein the hydrocarbon is a polyolefin, a paraffin, or a combination thereof.

4. The separator of claim 1, wherein the phase change material includes a polymer.

5. The separator of claim 4, wherein the polymer is polyolefins, fluoropolymers, polyethylene oxides, acrylics, or a combination thereof.

6. The separator of claim 1, wherein the phase change material includes an ionic liquid.

7. The separator of claim 1, wherein the solid unencapsulated endothermic phase change material particles on the ceramic coating form a layer having a thickness of about 0.5 to 10 μm.

8. The separator of claim 1, wherein the phase transition temperature is in the range of about 90 to 150° C.

9. A battery cell comprising:
positive and negative electrodes;
a separator, disposed between the electrodes, including a porous substrate, a ceramic coating on opposite sides of the porous substrate, and solid unencapsulated endothermic phase change material particles on or in the ceramic coating and configured to melt upon achieving a phase transition temperature, fill pores on the sides, and hinder ion transport between the electrodes; and
electrolyte saturating the separator and in contact with the electrodes.

10. The battery cell of claim 9, wherein the phase change material includes a hydrocarbon.

11. The battery cell of claim 10, wherein the hydrocarbon is polyolefins, paraffins, or a combination thereof.

12. The battery cell of claim 9, wherein the phase change material includes a polymer.

13. The battery cell of claim 12, wherein the polymer is polyolefins, fluoropolymers, polyethylene oxides, acrylics, or a combination thereof.

14. The battery cell of claim 9, wherein the phase change material includes an ionic liquid.

15. A battery cell comprising:
positive and negative electrodes;
a separator, disposed between the electrodes, including a porous substrate and solid unencapsulated endothermic phase change material particles configured to melt upon achieving a phase transition temperature, fill pores of the porous substrate, and hinder ion transport between the electrodes; and
electrolyte saturating the separator and in contact with the electrodes.

16. The battery cell of claim 15, wherein the separator further includes a ceramic coating configured to increase permeability and electrolyte wettability.

17. The battery cell of claim 16, wherein ceramic particles include alumina, boehmite, silica, or a combination thereof.

18. The battery cell of claim 16, wherein ceramic particles have a D50 between 0.1 and 2 μm.
